(19) United States
(12) Patent Application Publication
(10) Pub. No.: US 2015/0256900 A1
(43) Pub. Date: Sep. 10, 2015

(54) DYNAMIC CONTENT CREATION FOR INTERACTIVE VIDEO OVERLAYS

(71) Applicant: BlurbIQ, Inc., Las Vegas, NV (US)

(72) Inventors: Scott Reese, Las Vegas, NV (US); Derrick Horner, Guttenberg, NJ (US); Andrew Spencer, Garden Grove, CA (US)

(21) Appl. No.: 14/637,011

(22) Filed: Mar. 3, 2015

Related U.S. Application Data
(60) Provisional application No. 61/947,784, filed on Mar. 4, 2014.

(51) Int. Cl. H04N 21/81; H04N 21/475; H04N 21/234

(52) U.S. Cl. CPC H04N 21/812; H04N 21/23424; H04N 21/4758

(57) ABSTRACT

A method of providing an entertaining interaction between a user and a displayable multimedia packet includes obtaining a multimedia packet relating to a product, service or provider; obtaining a series of queries relating to the product, service or provider; establishing a predetermined elapsed time of the multimedia packet at which various queries will be presented to the user; presenting the multimedia packet to the user; and presenting to the user one or more of the queries at the predetermined elapsed time.

### PRIORITY CLAIM

Priority is claimed of and to U.S. Provisional Patent Application Ser. No. 61/947,784, filed Mar. 4, 2014, which is hereby incorporated herein by reference in its entirety.

### FIELD OF THE INVENTION

### Background

Interactive overlays on video advertising (hereinafter “video overlays”) are becoming increasingly effective at improving the performance of online video advertising. Within the very competitive online advertising market, it is not surprising that video overlays are playing a more important role in video advertising to create more engaging and interactive consumer experiences. The collection and analysis of data associated with actions, preferences and/or opinions of consumers is of interest, for example, in facilitating improvement of processes, products, or services. For example, a provider of a product may wish to know the preferences of consumers with respect to attributes of the product or opinions about the product, whether the opinions are positive or negative.

### BRIEF DESCRIPTION OF THE DRAWINGS

FIG. 1 illustrates, in schematic form, an exemplary display screen of an advertisement presentation in accordance with an embodiment of the present system;

FIG. 2 illustrates an exemplary flow chart depicting one aspect of the system of the present invention;

FIG. 3 illustrates an exemplary flow chart depicting an additional method of using the system of the present invention;

FIG. 4 depicts an exemplary system in accordance with an aspect of the present invention; and

FIG. 5 depicts an alternative system in accordance an aspect of the present invention.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

The present invention relates generally to systems and methods for advertising services or products through multimedia interfaces. More particularly, the present invention provides interactive advertising platforms and methods that can utilize an entertaining game interface to present users with advertising content, such as those interfaces described in U.S. patent application Ser. No. 12/878,558, which is hereby incorporated herein by reference in its entirety.

Embodiments of the present invention generally relate to systems and methods for providing contextual video overlays on video advertisements presented to a user in association with web pages or web sites. The invention, while not intended to be limiting, may be employed, for example, on Flash-based game websites, or online television or movie viewing sites that may have sponsored advertising hosted on a website, corporate websites, or across online advertising networks etc. The systems and methods of the invention can also be adapted for use with handheld devices (e.g., PDAs (Personal Digital Assistants), cell phones, tablets, personal computers, etc.).

In accordance with one embodiment, content to be included in a contextual video overlay can be received and a web site or web page is identified. Based on the content of the target web site or web page, the contextual video overlay is generated and presented to the user. For example, a user may visit a website, and because the website host has sponsoring advertisers, advertisements associated with the sponsor may trigger the presentation to a user of a video overlay regarding the products of that sponsor. Specific embodiments of the present invention relate to using content associated with the target web site, content associated with the target web page, a user profile, or a combination thereof, to generate the contextual advertisement. For example, elaborating upon the example mentioned above, a website may have multiple sponsoring advertisers, and the website itself may trigger the presentation of a video overlaid advertisement, whether or not the specific advertisement may is yet determined. In order to determine the most appropriate advertisement the system of the present invention may retrieve information from the user's cookie cache or browser history to determine which products and advertisements may be more effective in appealing to the user.

Further examples and features are discussed below in which the system can individualize and tailor each advertisement to each user even more specifically. Additional objects, advantages, and novel features of the invention will be set forth in part in the description which follows, which will become apparent to those skilled in the art upon examination of the following, or may be learned by practice of the invention.

### DETAILED DESCRIPTION

Before the present invention is disclosed and described, it is to be understood that this invention is not limited to the particular structures, process steps, or materials disclosed herein, but is extended to equivalents thereof as would be recognized by those of ordinarily skilled in the relevant arts. It should also be understood that terminology employed herein is used for the purpose of describing particular embodiments only and is not intended to be limiting.

It must be noted that, as used in this specification and the appended claims, the singular forms “a” and “the” can include plural referents, unless the context clearly dictates otherwise. Thus, for example, reference to a “display screen” can include reference to one or more of such display screens.

### DEFINITIONS

In describing and claiming the present invention, the following terminology will be used in accordance with the definitions set forth below.

As used herein, the term “display screen” or “display” is used to refer to a display suitable for use in displaying a variety of types of multimedia packets to a consumer. Typically, such displays will be electronic in nature: exemplary displays include, without limitation, computer monitors, PDA screens, cell phone screens, televisions, and the like.

As used herein, the term “multimedia packet” is used to refer to a variety of types of data that can be presented to a viewer. Suitable packets can include, without limitation, video data, audio data, image file data, and combinations and collections thereof. Generally, a multimedia packet will have a natural, predefined elapsed time sequence: in other words, it can be played from beginning to end with the multimedia packet data presenting data consistently through the same elapsed time frame. Thus, such packets generally include a beginning and an end, and the intermediate portions of the packet are presented consistently therebetween.

As used herein, the term “substantially” refers to the complete, or nearly complete, extent or degree of an action, characteristic, property, state, structure, item, or result. As an arbitrary example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained.

The use of “substantially” is equally applicable when used in a negative connotation to refer to the complete or near complete lack of an action, characteristic, property, state, structure, item, or result. As another arbitrary example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, the term “about” is used to provide flexibility to a numerical range endpoint by providing that a given value may be “a little above” or “a little below” the endpoint.

Distances, forces, weights, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited.

As an illustration, a numerical range of “about 1 inch to about 5 inches” should be interpreted to include not only the explicitly recited values of about 1 inch to about 5 inches, but also include individual values and sub-ranges within the indicated range. Thus, included in this numerical range are individual values such as 2, 3, and 4 and sub-ranges such as from 1-3, from 2-4, and from 3-5, etc.

This same principle applies to ranges reciting only one numerical value and should apply regardless of the breadth of the range or the characteristics being described.

Examples are provided herein that include various hardware and modules. Various methods consistent with several examples can also be described in relation to the following figures. Such methods can be depicted with functional blocks. These functional blocks can depict steps, or operations, consistent with examples of such methods. Such steps, or operations, can be implemented in computer program code. Although functional blocks can be depicted in order, the order in which they are depicted can, in many instances, be reversed, and does not necessarily indicated a necessary chronological order in which the corresponding steps, or operations, are performed. Several additional methods not depicted can also be consistent with additional examples.

Some of the functional units described in this specification have been labeled as modules, in order to more particularly emphasize their implementation independence. For example, a module can be implemented as a hardware circuit comprising custom VLSI circuits or gate arrays, off-the-shelf semiconductors such as logic chips, transistors, or other discrete components. A module can also be implemented in programmable hardware devices such as field programmable gate arrays, programmable array logic, programmable logic devices or the like.

Modules can also be implemented in software for execution by various types of processors. An identified module of executable code can, for instance, comprise one or more blocks of computer instructions, which can be organized as an object, procedure, or function. Nevertheless, the executables of an identified module need not be physically located together, but can comprise disparate instructions stored in different locations which comprise the module and achieve the stated purpose for the module when joined logically together.

Indeed, a module of executable code can be a single instruction, or many instructions, and can even be distributed over several different code segments, among different programs, and across several memory devices. Similarly, operational data can be identified and illustrated herein within modules, and can be embodied in any suitable form and organized within any suitable type of data structure. The operational data can be collected as a single data set, or can be distributed over different locations including over different storage devices. The modules can be passive or active, including agents operable to perform desired functions.

The technology described here can also be stored on a computer readable storage medium that includes volatile and non-volatile, removable and non-removable media implemented with any technology for the storage of information such as computer readable instructions, data structures, program modules, or other data. Computer readable storage media includes, but is not limited to, RAM, ROM, EEPROM, flash memory or other memory technology, CD-ROM, digital versatile disks (DVD) or other optical storage, magnetic cassettes, magnetic tapes, magnetic disk storage or other magnetic storage devices, or any other computer storage medium which can be used to store the desired information and described technology.

The devices described herein can also contain communication connections or networking apparatus and networking connections that allow the devices to communicate with other devices. Communication connections are an example of communication media. Communication media typically embodies computer readable instructions, data structures, program modules and other data in a modulated data signal such as a carrier wave or other transport mechanism and includes any information delivery media. A “modulated data signal” can mean a signal that has one or more of its characteristics set or changed in such a manner as to encode information in the signal. By way of example, and not limitation, communication media includes wired media such as a wired network or direct-wired connection, and wireless media such as acoustic, radio frequency, infrared, and other wireless media. The term computer readable media as used herein includes communication media.

Furthermore, the described features, structures, or characteristics can be combined in any suitable manner in one or more examples. In the following description, numerous specific details are provided, such as examples of various configurations to provide a thorough understanding of examples of the described technology. One skilled in the relevant art will recognize, however, that the technology can be practiced without one or more of the specific details, or with other methods, components, devices, etc. In other instances, well-known structures or operations are not shown or described in detail to avoid obscuring aspects of the technology.

Invention

The content of interactive video overlays on video advertisements may generally be classified either as static or dynamic. Static content in video overlays generally is presented via manual selection and sequencing with the associated video advertisement, e.g., may contain questions that are pre-loaded and ordered to correspond with a particular video advertisement prior to a user viewing the advertisement and without association to any characteristics of the user or the website or webpage via which the video advertisement is being viewed.

Dynamic content in video overlays, on the other hand, may be presented via automated selection from a set of content with selection being determined based on relevant characteristics of the consumer and/or the website or webpage via which the consumer is viewing the video advertisement, e.g., may contain questions selected from a pre-loaded set of questions each chosen based on the prior online behavior of the consumer or the content of the website or webpage where the consumer is watching a video advertisement.

Accordingly, dynamic content in video overlays may be used to provide a more individualized, interactive, and user-friendly experience for the consumer. Consequently, a designer or manager of dynamic content in a video overlay on video advertising may obtain more, and more meaningful, user interactions with the content of the overlay.

Current models for content in video overlays are not developed to dynamically create content in video overlays using relevant information about the consumer or the web site or web page content being viewed by the consumer viewing the video advertisement. “Contextual video overlays,” as used herein, can generally refer to video overlays on video advertisements, having dynamically created content, that utilize information from the hosting resource (e.g., a web site, a web page, etc.) that displays the video advertisement to a consumer. Contextual video overlays may provide more specific video overlays to consumers using relevant consumer information and/or contextual information associated with the website or webpage hosting and/or displaying the video advertisement to the consumer.

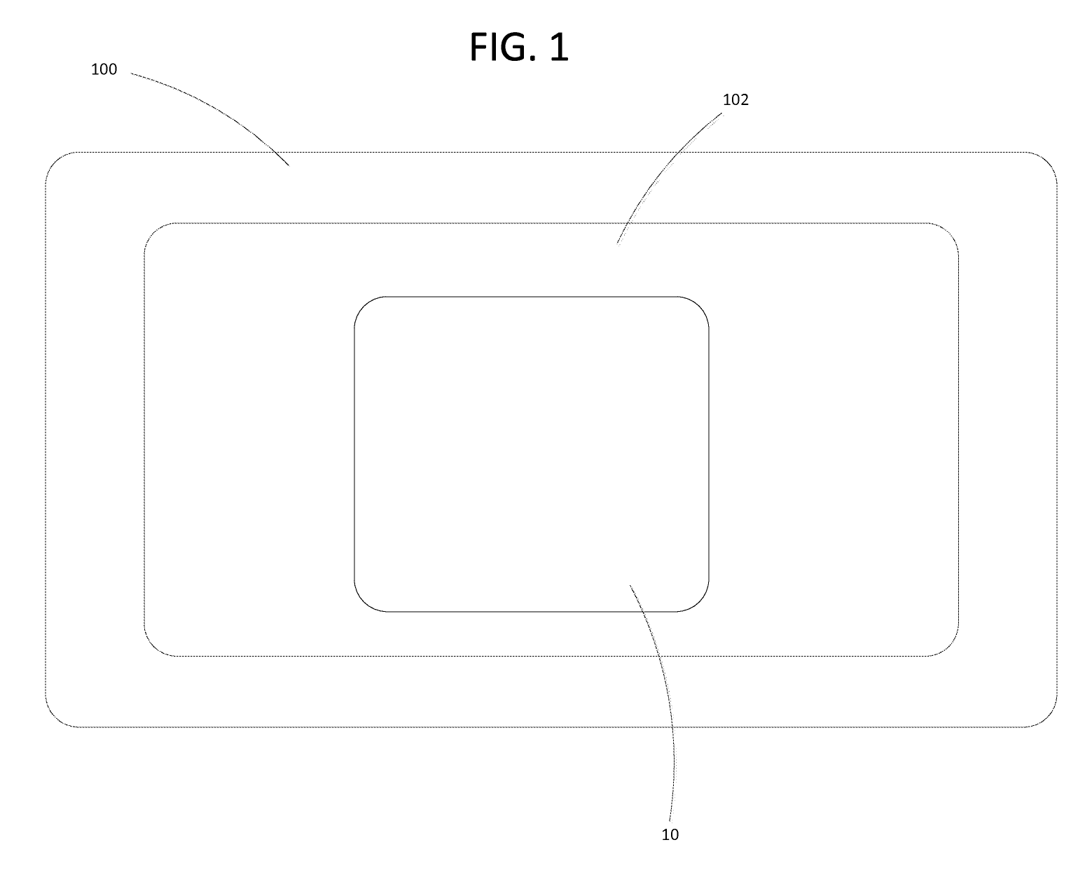

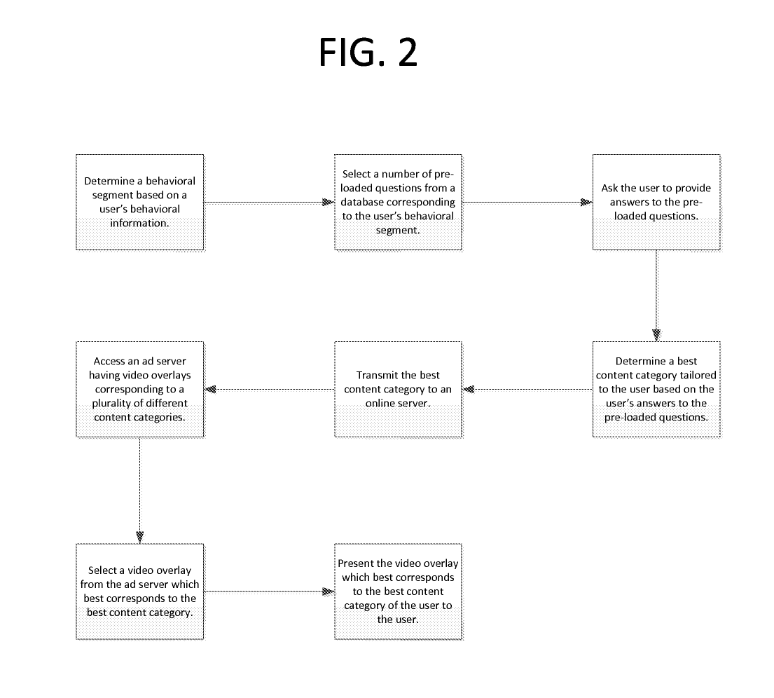

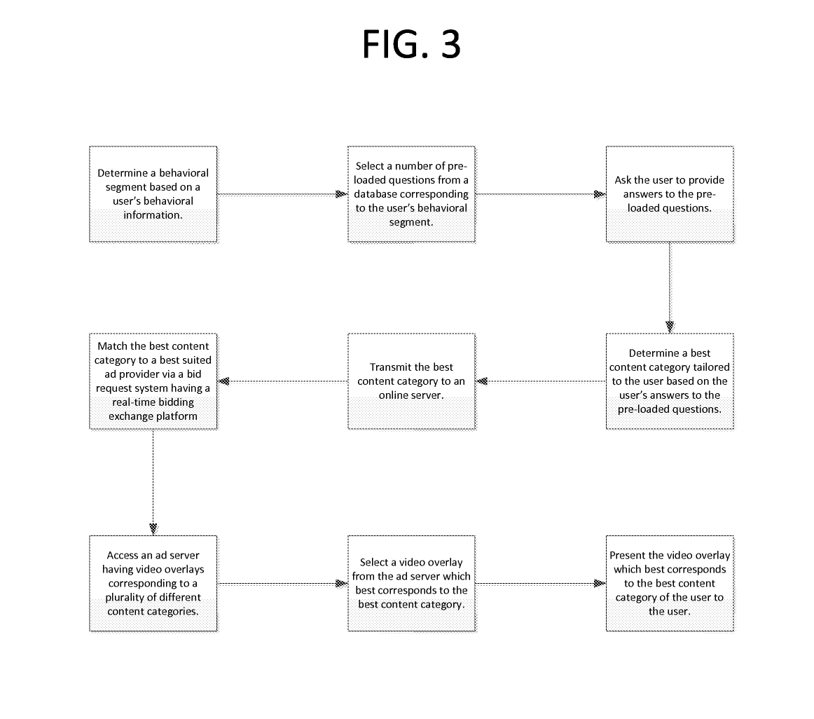

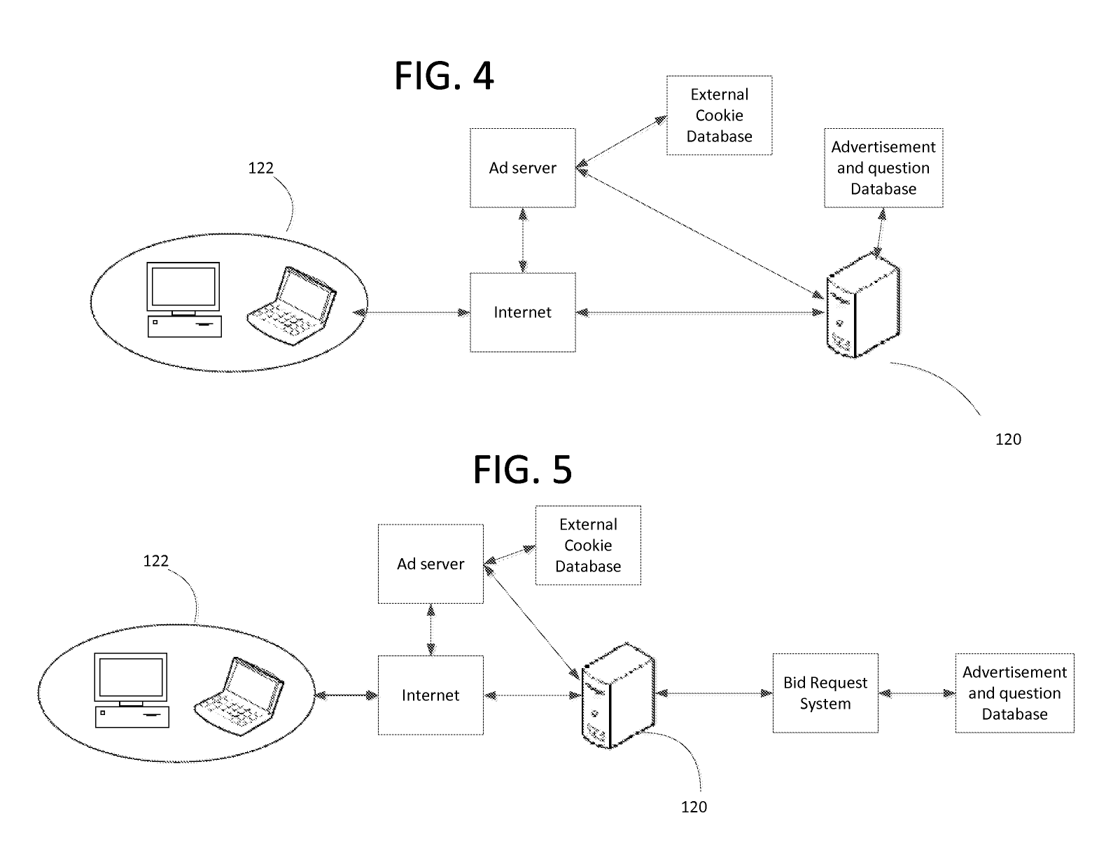

As shown generally in FIG. 1, a user may be viewing content on a computer screen or monitor 100. The content may be presented via a web browser 102. In one embodiment of the dynamic video content display system of the present invention, a contextual video overlay is displayed to the user. This contextual video overlay is chosen based on an automated selection of questions from a pre-loaded set of questions relating to services provided by advertisers, with selection being based on the behavioral segmentation of users viewing a video advertisement. In this embodiment, a user identified with a particular online behavioral segment will be shown questions relevant to their interests, or which otherwise use relevant behavioral information about the user, and are also associated with the video advertisement.

For example, a sports enthusiast may visit a sports website, and, while on the website, the user may be presented with an opportunity to view a video advertisement with a contextual video overlay. The contextual overlay may utilize the information that the user is viewing the advertisement via a sports website: the advertisement may insert the antecedent phrase “Hey [sports] fan!” prior to a pre-loaded question as an overlay on the advertisement. As a further example, a sports enthusiast may view a video advertisement for an automobile via a sports website with a contextual video overlay inserting an antecedent phrase prior to a pre-loaded question such as “Hey [sports] fan! Looking for a new [car] to drive to the [big game]?”

As another example, a football enthusiast may view a video advertisement for an automobile with a contextual video overlay inserting an antecedent phrase prior to a pre-loaded question such as “Hey [football] fan! Looking to drive a new [car] soon?”

As another example, on a date prior to the date upon which the Super Bowl will take place, a football enthusiast may view a video advertisement for an automobile with a contextual video overlay inserting an antecedent phrase prior to a pre-loaded question such as “Hey [football] fan! Looking to drive a new [car] to the [Super Bowl]?”

With reference to the figures, in each of the foregoing examples, using brackets for emphasis only, each of the bracketed words can reflect an automated pre-loaded question selection based on the behavioral segment of the user wherein the behavioral segment of the foregoing examples is based upon the portal or website through which the user is viewing the advertisement.

However, the behavioral segment of the user may be based upon more information than only the portal or website hosting the advertisement and there may be more than one advertiser or service for which advertisement may be being offered. For example, questions can be pre-loaded into a database and associated with one or more behavioral segment definitions. The database can be stored either on a local client or a remote server. Behavioral segment definitions can also be defined by a set of associated keywords. When a consumer initiates a video advertisement, information regarding the user's behavioral segment may be determined externally, for example, by an ad server that stores a cookie on the consumer's computer that identifies a behavioral segment classification and reveals that classification in a database. For example, if a user has visited multiple car dealership sites and the sites have stored cookies in the user's cache, the system 120 of the present invention may access the user's cache and recognize the occurrences of car shopping related cookies which may indicate that the user may be interested in a new car. These user interests may be referred to as the user's behavioral segment. This behavioral segment can then be used to present the user with targeted ads to which the user is most likely receptive. The relevant behavioral segment information can be transmitted to the system 120, or the system 120 can access the cookie on the user's computer 122 or the external cookie database, then the system 120 can identify the user's behavioral segment and determine an antecedent phrase or question that matches the behavioral segment classification. The phrase or pre-loaded question can then be selected in the creation of a contextual video overlay on the video advertisement viewed by the consumer.

In another aspect of the invention, a contextual video overlay can be created from the automated selection of questions from a pre-loaded set of questions with selection being based on the content of the portal, i.e. website or webpage, through which a user is viewing a video advertisement. In this embodiment, a user will be shown questions relevant to the particular category of content of a website or webpage, or which otherwise use relevant information about the website or webpage, and which is also associated with the video advertisement.

For example, a user initiating a video advertisement from a website related to sports may view a video advertisement with a contextual video overlay inserting the antecedent phrase “Hey [sports] fan!” prior to a question. As a further example, a user initiating a video advertisement from a website related to sports on a page about football may view a video advertisement for an automobile with a contextual video overlay inserting the antecedent phrase prior to a question such as “Hey [football] fan! Looking for a new [car] to drive to the [big game]?” In each of the foregoing examples, the brackets are used to identify an exemplary automated selection based on the content of the website or webpage being viewed by the user.

As another example, on a date prior to the date upon which the Super Bowl will take place, a user initiating a video advertisement from a website related to sports on a page about football may view a video advertisement for an automobile with a contextual video overlay inserting the antecedent phrase prior to a question such as “Hey [football] fan! Looking for a new [car] to drive to the [Super Bowl]?” In this example, the Super Bowl is used as but one example of a major event that may attract user's attention. Other non-limiting examples include the World Series, the World Cup, etc.

In the foregoing exemplary embodiments, questions can be pre-loaded in a database and associated with one or more content categories. Content categories can also be defined by a set of associated keywords. When a consumer initiates a video advertisement, information regarding the website and/or webpage may be determined externally, for example, by the system 120 or an ad server can identify the website and/or webpage by a uniform resource locator. The system 120 can then determine a content category and can locate that category in an advertisement and question database. The relevant content category information can be transmitted to the system 120, or the system or server 120 can access the ad server and external cookie database, after which the system can identify the content category of the website or webpage and can determine an antecedent phrase or question that matches the category from the advertisement and question database. The phrase or question can then be selected in the creation of a contextual video overlay on the video advertising viewed by the consumer.

In another aspect of the present invention, a contextual video overlay can be created from the automated selection of questions from a pre-loaded set of questions with selection being based on both the behavioral segmentation of users viewing a video advertisement and the content of the website or webpage through which the user is viewing a video advertisement. In this embodiment, a user identified with a particular online behavioral segment can be shown questions relevant to their interests, or which otherwise use relevant behavioral information about the user, and questions relevant to the particular category of content of a website or webpage, or which otherwise use relevant information about the website or webpage, and are also associated with the video advertisement.

For example, a football enthusiast initiating a video advertisement from a website related to the Dallas cowboys on a webpage about the Dallas Cowboys' cheerleaders may view a video advertisement for an automobile with a contextual video overlay inserting the antecedent phrase prior to a question such as “Hey [football] fan! Looking for a new [car] to impress the [ladies] in [Dallas]?” Again, the bracketed words are used here for emphasis only and can reflect an automated selection based on the user's behavioral segment and/or the content of the website or webpage being viewed by the user.

In the foregoing exemplary embodiments, questions can be pre-loaded into a database and associated with one or more behavioral segment definitions and content categories. Behavioral segment definitions and content categories can be defined by a set of associated keywords. When a consumer initiates a video advertisement, information relating to the user's behavioral segment and the website and/or webpage may be determined externally, for example, by an ad server that stores a cookie on the consumer's computer which determines a behavioral segment classification and reveals that classification in a database, and identifies a website and/or webpage by a uniform resource locator, and that determines a content category and identifies that category in a database. In other words the behavioral segment may be determined exclusively by the website or portal through which the user is accessing the advertisement, or exclusively by behavioral information such as cookies stored on the user's computer, or both of these methods may be used together in order to form a more accurate behavioral segment for the user. The relevant behavioral segment and content category information can be transmitted to or from the user's computer (or local client) 122 to the system 120 (including one or more remote servers), or the system 120 can access an external cookie database, then the system 120 can identify the behavioral segment of the user and content category of the website or webpage and can determine an antecedent phrase or question that matches the segment and category.

The phrase or question can then be selected in the creation of a contextual video overlay on the video advertising viewed by the consumer. For example, the system can access information about the user's behavioral segment from an external database or external data provided by an advertising exchange system, including a real-time advertising exchange system. In addition, in the latter case, the system can make a real-time determination of which antecedent phrase or question matches the segment or category of the user by accessing information supplied by a real-time advertising exchange system when requests to bid on advertising inventory are solicited by the real-time advertising exchange system.

In another aspect of the present invention, an interactive search option may be overlaid on the video rather than a pre-loaded set of question. In other words, instead of presenting a pre-loaded set of questions with an antecedent phrase matching the user's behavioral segment, the system 120 may instead present a search bar to the user wherein the user may interactively search for content related to the contextual video overlay, and then from the search results select content pertaining to the user's interests. For example, a contextual video overlay on a video advertisement for an automobile manufacturer may contain a search bar that conducts a search of the web site or web page of the automobile manufacturer. In this example, a user inputs a keyword or set of keyword into the search bar and the search bar utilizes the web site or web page search capability of the automobile manufacturer and passes a keyword or set of keywords to the web site or web page search capability of the automobile manufacturer to process the search query. The user is then presented with search results selected from the web site or web page of the automobile manufacturer.

In another aspect of the present invention, a pre-populated search overlay may be overlaid on the video ad. Meaning, that the system may have a pre-generated keyword or set of keywords to be used to conduct a search query which correlates to the portal or website through which the user is viewing the content. For example, a contextual video overlay on a video advertisement for an automobile manufacturer may contain a search bar that conducts a search of the web site or web page of the automobile manufacturer. In this example, the search bar is pre-populated with a keyword or set of keywords that correlate to the content on the web page where the video ad is viewed. When the user conducts a search, the search bar utilizes the web site or web page search capability of the automobile manufacturer and passes a keyword or set of keyword to the web site or web page search capability of the automobile manufacturer to process the search query. The user is then presented with search results selected from the web site or web page of the automobile manufacturer.

In another aspect of the present invention, a dynamic pre-populated search overlay may be overlaid on the video ad. The search overlay can be pre-populated with a keyword or set of keywords that appear in the search box based on the elapsed time of the video ad. For example, a contextual video overlay on a video ad for an automobile manufacturer may contain a search bar that conducts a search of the web site or web page of the automobile manufacturer. In this example, the search bar is pre-populated with a keyword or set of keywords that correlate to the content of the video ad. The keyword or set of keywords can be manually input into the system and sequenced top the video ad so that a different keyword or set of keywords will appear in the search box based on the time elapsed during the video ad. When the user conducts a search, the search bar can utilize the web site or web page search capability of the automobile manufacturer and passes a keyword or set of keyword to the web site or web page search capability of the automobile manufacturer to process the search query. The user is then presented with search results selected from the web site or web page of the automobile manufacturer.

In accordance with another aspect of the invention, the dynamic overlay can be formed based on the CSS/style sheet of the web page where the video is watched. In this manner, the native look and feel of the web page can be better replicated within the dynamic overlay through matching of fonts, colors scheme, etc. Also, the dynamic overlay can be formed based on other page elements/attributes of the web page where the video is being watched. These include, without limitation: keywords, which can be selected from page generally or from headline of editorial on page; and images, which can be selected from editorial image on page, etc., such that the dynamic overlay can include text, images and other graphics from the web page.

In another example, the dynamic overlay can be formed using data correlated with the IP address of the viewer such as weather conditions in the location of the viewer. For example, the when the system determines that a user is generally located in New York, or specifically in New York City, a dynamic overlay can be formed with the phrase “It's 20 degrees in New York today! What do you do when it is this cold?!” In addition, the dynamic overlay can be formed with graphical effects that resemble snow flurries based on data correlated with the IP address of the viewer.

What is claimed is:

1. A method of providing advertisement video overlays having dynamic content comprising:
obtaining a pre-loaded set of questions;
obtaining answers to the pre-loaded set of questions wherein the answers reflect a user's personal characteristics;
determining a best content category tailored to the user;
transmitting the best content category to a server;
accessing an advertising (“ad”) server having video overlays corresponding to multiple different content categories;
selecting a dynamic video overlay which corresponds to the best content category; and
presenting the dynamic video overlay to the user.

2. The method of claim 1, wherein the answers to the pre-loaded set of questions are determined, at least in part, by information regarding the user's online behavior.

3. The method of claim 1, wherein the answers to the pre-loaded set of questions are determined, at least in part, by categorizing the portal through which the user is viewing the content.

4. The method of claim 1, wherein the answers to the pre-loaded set of questions are determined, at least in part, by a combination of information regarding the user's online behavior and categorizing the portal through which the user is viewing the content.

5. The method of claim 1, wherein the user's content category is transmitted to the server through a bid request system having a real-time bidding exchange platform.
